(19) United States
(12) Patent Application Publication
(10) Pub. No.: US 2026/0199786 A1
(43) Pub. Date: Jul. 16, 2026

(54) METHOD AND DEVICE FOR CONTROLLING VIRTUAL CHARACTER, NON-TRANSITORY COMPUTER STORAGE MEDIUM AND ELECTRONIC DEVICE

(71) Applicant: NETEASE (HANGZHOU) NETWORK CO., LTD., Hangzhou, Zhejiang (CN)

(72) Inventor: Jiaxu WANG, Guangzhou, Guangdong (CN)

(73) Assignee: NETEASE (HANGZHOU) NETWORK CO., LTD., Hangzhou, Zhejiang (CN)

(21) Appl. No.: 19/136,863

(22) PCT Filed: Aug. 15, 2023
(86) PCT No.: PCT/CN2023/113165

§ 371 Date: Jun. 7, 2025

(30) Foreign Application Priority Data
Dec. 8, 2022 (CN) 202211573492.4

(51) Int. Cl. A63F 13/58; A63F 13/533

(52) U.S. Cl. CPC A63F 13/58; A63F 13/533

(57) ABSTRACT

A method for controlling a virtual character includes: in response to a first operation for a first control area, controlling a viewing direction of the virtual character to rotate at a first preset speed, wherein a graphical user interface is provided by a terminal device, the graphical user interface at least includes the first control area, a second control area, a game scene and the virtual character; in response to a second operation for the second control area, controlling the virtual character to move in a current viewing direction; in response to the virtual character entering a designated area, generating a third control area in the graphical user interface; and in response to a third operation for the third control area, controlling the viewing direction of the virtual character to rotate at a second preset speed; wherein the first preset speed is greater than the second preset speed.

### CROSS-REFERENCE TO RELATED APPLICAITON

The present disclosure is a U.S. National Stage Application of International Application No. PCT/CN 2023/113165, filed on Aug. 15, 2023, which is based upon and claims the priority to the Chinese Patent Application NO. 202211573492.4, entitled “METHOD AND DEVICE FOR CONTROLLING VIRTUAL CHARACTER, COMPUTER STORAGE MEDIUM, AND ELECTRONIC DEVICE”, filed on Dec. 8, 2022, the entire contents of which are incorporated herein by reference for all purposes.

### TECHNICAL FIELD

Embodiments of the present disclosure relate to the field of computer technologies, and in particular, to a method and device for controlling a virtual character, a non-transitory computer storage medium, and an electronic device.

### BACKGROUND

Open world games, also known as free-roaming games, are games in which players can explore every corner of the map by controlling virtual characters. To facilitate the players to explore freely in areas with complex terrain in the map, an automatic vaulting function has been added to the existing games, that is, when the virtual character is at an edge of a wall or the like, the virtual character can automatically vault the obstacle without the player control.

It should be noted that the information disclosed in the background section above is only used to enhance the understanding of the background of the present disclosure, and therefore may include information that does not constitute the prior art known to those skilled in the art.

### SUMMARY

According to an aspect of the present disclosure, there is provided a method for controlling a virtual character, including:
in response to a first operation for a first control area, controlling a viewing direction of the virtual character to rotate at a first preset speed;
in response to a second operation for a second control area, controlling the virtual character to move in a current viewing direction;
in response to the virtual character entering a designated area, generating a third control area in a graphical user interface; and
in response to a third operation for the third control area, controlling the viewing direction of the virtual character to rotate at a second preset speed;
wherein the first preset speed is greater than the second preset speed.

According to an aspect of the present disclosure, there is provided a non-transitory computer storage medium having a computer program stored thereon, wherein the computer program, when executed by a processing unit, implements the method for controlling the virtual character described in any of the above embodiments.

According to an aspect of the present disclosure, there is provided an electronic device, including:
a processing unit; and
a storage unit, configured to store executable instructions of the processing unit;
wherein the processing unit is configured to execute, by executing the executable instructions, the method for controlling the virtual character described in any of the above embodiments.

It should be understood that the above general description and the following detailed description are merely exemplary and explanatory, and should not limit the present disclosure.

### BRIEF DESCRIPTION OF THE DRAWINGS

The drawings herein are incorporated in and constitute a part of the specification, illustrate embodiments consistent with the present disclosure, and together with the description serve to explain principles of the present disclosure. Apparently, the drawings in the following description are only some embodiments of the present disclosure. For those of ordinary skill in the art, other drawings may be obtained based on these drawings without paying any creative effort.

FIG. 1 schematically shows a flowchart of a method for controlling a virtual character according to an embodiment of the present disclosure.

FIG. 2 schematically shows a graphical user interface diagram when a game scene does not include a designated area according to an embodiment of the present disclosure.

FIG. 3 schematically shows a graphical user interface diagram in which a designated area exists in a game scene and a user controls a virtual character to enter the designated area according to an embodiment of the present disclosure.

FIG. 4 schematically shows a graphical user interface diagram in which a designated area exists in a game scene and a user controls a virtual character to enter the designated area according to an embodiment of the present disclosure.

FIG. 5 schematically shows a flowchart of a method for generating a third control area in a graphical user interface in response to a virtual character entering a designated area according to an embodiment of the present disclosure.

FIG. 6 schematically shows a graphical user interface diagram in which a designated area exists in a game scene and a user controls a virtual character to enter the designated area according to an embodiment of the present disclosure.

FIG. 7 schematically shows a block diagram of a device for controlling a virtual character according to an embodiment of the present disclosure.

FIG. 8 schematically shows an electronic device according to an embodiment of the present disclosure.

### DETAILED DESCRIPTION

Example embodiments will now be described more fully with reference to the accompanying drawings. However, the example embodiments may be implemented in a variety of forms and should not be construed as being limited to examples set forth herein; rather, these embodiments are provided so that the present disclosure will be more complete and comprehensive so as to convey the spirit of the example embodiments to those skilled in this art. The described features, structures, or characteristics may be combined in any suitable manner in one or more embodiments. In the description below, numerous specific details are set forth to provide a thorough understanding of embodiments of the present disclosure. However, those skilled in the art will appreciate that the technical solution of the present disclosure may be practiced without one or more of the specific details, or other methods, components, devices, steps and the like may be employed. In other instances, well-known technical solutions are not shown or described in detail to avoid obscuring various aspects of the present disclosure.

In addition, the drawings are merely schematic representations of the present disclosure and are not necessarily drawn to scale. The same reference numerals in the drawings denote the same or similar parts, and the repeated description thereof will be omitted. Some of the block diagrams shown in the figures are functional entities and do not necessarily correspond to physically or logically separate entities. These functional entities may be implemented in software, or implemented in one or more hardware modules or integrated circuits, or implemented in different networks and/or processor devices and/or microcontroller devices.

A seamless large map of current open world games has attracted a large number of users as the highlight of the open world games. The users can reach any scene in the world by controlling virtual characters in the games. At present, an automatic vaulting function has been implemented in the games, which reduces the difficulty of users'movement operations on the complex terrain.

However, when the user controls the virtual character to move on the complex terrain such as stairs or low walls, due to the automatic vaulting function and limited mobile phone operations, especially when the user's movement operation habits remain consistent on the flat ground and on the complex terrain, it is easy to move the virtual character to an edge of a railing, and then trigger the vaulting operation, causing the virtual character to vault the railing, and seriously affecting the user's gaming experience.

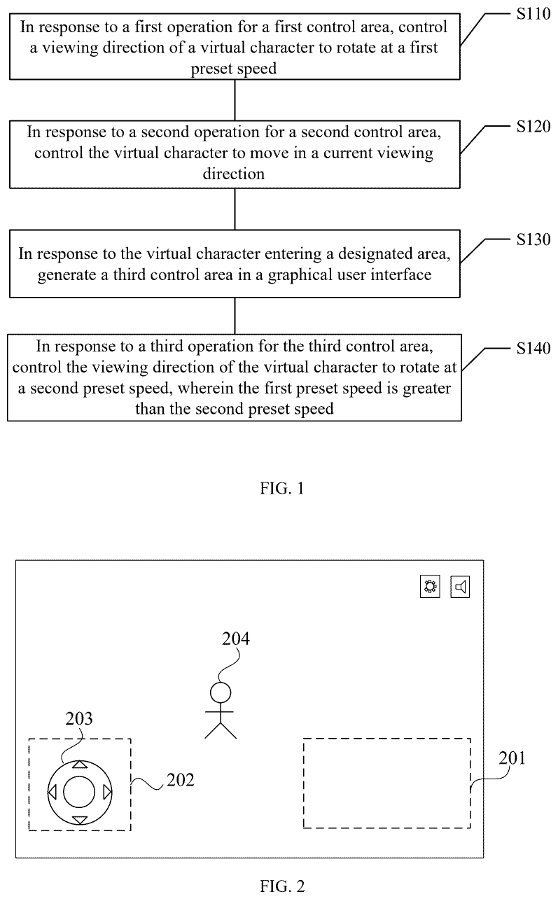

Based on the above one or more problems, embodiments first provide a method for controlling a virtual character, which can be run on a terminal device. The terminal device can include a desktop computer, a portable computer, a smart phone, a tablet computer, etc. Alternatively, those skilled in the art can also run the method of the present disclosure on other platforms as desired, which is not specifically limited by the embodiments. Referring to FIG. 1, the method for controlling the virtual character may include steps S110 to S140.

In the step S110, in response to a first operation for a first control area, a viewing direction of the virtual character is controlled to rotate at a first preset speed.

In the step S120, in response to a second operation for a second control area, the virtual character is controlled to move in a current viewing direction.

In the step S130, in response to the virtual character entering a designated area, a third control area is generated in a graphical user interface.

In the step S140, in response to a third operation for the third control area, the viewing direction of the virtual character is controlled to rotate at a second preset speed. The first preset speed is greater than the second preset speed.

In the method for controlling the virtual character as mentioned above, in response to the first operation for the first control area, the viewing direction of the virtual character is controlled to rotate at the first preset speed; in response to the second operation for the second control area, the virtual character is controlled to move in the current viewing direction; in response to the virtual character entering the designated area, the third control area is generated in the graphical user interface; and in response to the third operation for the third control area, the viewing direction of the virtual character is controlled to rotate at the second preset speed; the first preset speed is greater than the second preset speed. On the one hand, in response to the user's first operation in the first control area and the user's second operation in the second control area, the movement of the virtual character is determined according to both the first operation in the first control area and the second operation in the second control area. However, when the virtual character enters the designated area, the third control area is generated in the graphical user interface, and the change of the control area serves as a prompt to the user. On the other hand, when the virtual character enters the designated area, in response to the user's third operation for the third control area, the viewing direction of the virtual character is controlled by the third operation, the viewing rotation speed of the virtual character in the third control area is less than the viewing rotation speed of the virtual character in the first control area, that is, when the third operation is performed in the third control area, the viewing direction of the virtual character will be controlled to be at a smaller viewing rotation speed, thereby avoiding the problem of accidental vaulting or falling caused by the user's misoperation in the designated area, improving the user's movement feel in complex scenes, reducing the response frequency of the hardware device, and facilitating to save the computing resources of the hardware device.

Hereinafter, steps involved in the method for controlling the virtual character according to embodiments of the present disclosure are explained and illustrated in detail.

First, application scenarios and purposes of embodiments of the present disclosure are explained and illustrated. Specifically, the embodiments of the present disclosure can be applied to games in which the automatic vaulting function of virtual characters has been realized, and mainly study how to avoid, in the complex terrain of the game, the problem of poor user gaming experience caused by the user's operation habit remaining unchanged in different areas or by accidentally triggering the vaulting operation by the user's misoperation.

In the present disclosure, on the basis of a game scene displayed in the graphical user interface, the designated area included in the current game scene is determined. When the user controls the virtual character to move in a non-designated area, the movement of the virtual character is determined according to both the first operation of the user in the first control area and the second operation of the user in the second control area. The viewing direction of the virtual character is controlled to rotate at the first preset speed in the first control area. When the virtual character enters the designated area, the third control area is generated in the graphical user interface, and in response to the third operation of the user in the third control area, the viewing direction of the virtual character is controlled, through the third operation, to rotate at the second preset speed less than the first preset speed. That is, when the virtual character moves in the designated area, the viewing direction rotation speed of the virtual character is reduced, and the problem of poor user gaming experience caused by accidentally triggering the vaulting operation, when the user continues to control the viewing direction of the virtual character to rotate at the first preset speed, due to the user's operation habit in the designated area remaining unchanged is reduced, thereby improving the user's gaming experience.

Next, the steps S110 to S140 of embodiments of the present disclosure are explained and illustrated.

In the step S110, in response to the first operation for the first control area, the viewing direction of the virtual character is controlled to rotate at the first preset speed.

In an embodiment, a terminal device of the user provides a graphical user interface, and the graphical user interface may include the first control area and the second control area. The first control area may be located on the right side of the graphical user interface, in which the user can control the virtual character through a first interactive medium. The first interactive medium may be the user's right hand finger, or a stylus, etc., and the first interactive medium is not specifically limited in the embodiment. The second control area may be located at the lower left of the graphical user interface, in which an operation control is provided. The operation control located in the second control area may be operated through a second interactive medium, and the second interactive medium may be the user's left hand finger, or the stylus, etc., which is not specifically limited in the embodiment. By operating the operation control, the virtual character can be controlled to move in the current viewing direction in the game scene.

In the embodiment, when the user performs the first operation in the first control area, in response to the first operation of the user, the viewing direction of the virtual character can be controlled according to the first operation. When the viewing direction of the virtual character is controlled by the first operation, the rotation speed of the viewing direction of the virtual character in the game scene is the first preset speed. There is no limitation on the first preset speed in the embodiment.

In the step S120, in response to the second operation for the second control area, the virtual character is controlled to move in the current viewing direction.

In the embodiment, when the user performs the second operation in the second control area, the user's second operation in the second control area for the virtual character is responded to, the second operation is used to control the movement of the virtual character. When the virtual character is controlled to move, a movement direction of the virtual character is determined by the current viewing direction of the virtual character, that is, the current viewing direction of the virtual character is determined by the first operation in the first control area.

In the step S130, in response to the virtual character entering the designated area, the third control area is generated in the graphical user interface.

As shown in FIG. 2, when there is no designated area in the current game scene displayed by the graphical user interface, the current graphical user interface may include a first control area 201, a second control area 202, an operation control 203 in the second control area 202, and a virtual character 204. However, when there is the designated area in the current game scene displayed by the graphical user interface, in response to the virtual character entering the designated area, the third control area may be generated in the graphical user interface. The third control area may be located above or below the first control area. The position of the generated third control area in the graphical user interface is specifically limited in the embodiment.

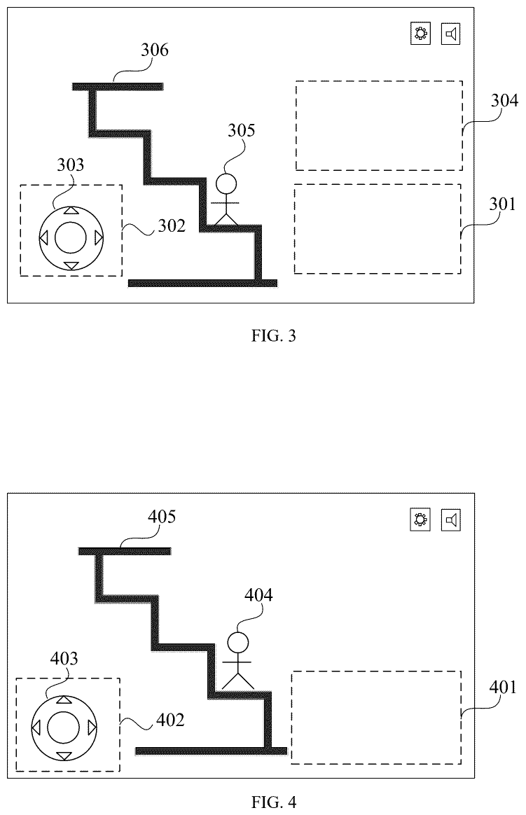

As shown in FIG. 3, there is a designated area 306 in the current game scene displayed by the graphical user interface, and when the user controls the virtual character to enter the designated area 306, the graphical user interface may further include a first control area 301, a second control area 302, an operation control 303 in the second control area 302, a third control area 304 and a virtual character 305.

In the embodiment, in response to the virtual character entering the designated area, generating the third control area in the graphical user interface may include:
in response to the virtual character entering the designated area, switching the first control area to the third control area.

Specifically, when the user controls the virtual character to enter the designated area, in response to the virtual character entering the designated area, the first control area in the graphical user interface is switched to the third control area.

As shown in FIG. 4, when the user controls the virtual character to enter the designated area of the game scene, that is, when the current game scene includes a designated area 405, the current graphical user interface may further include a third control area 401, a second control area 402, an operation control 403 in the second control area, and a virtual character 404.

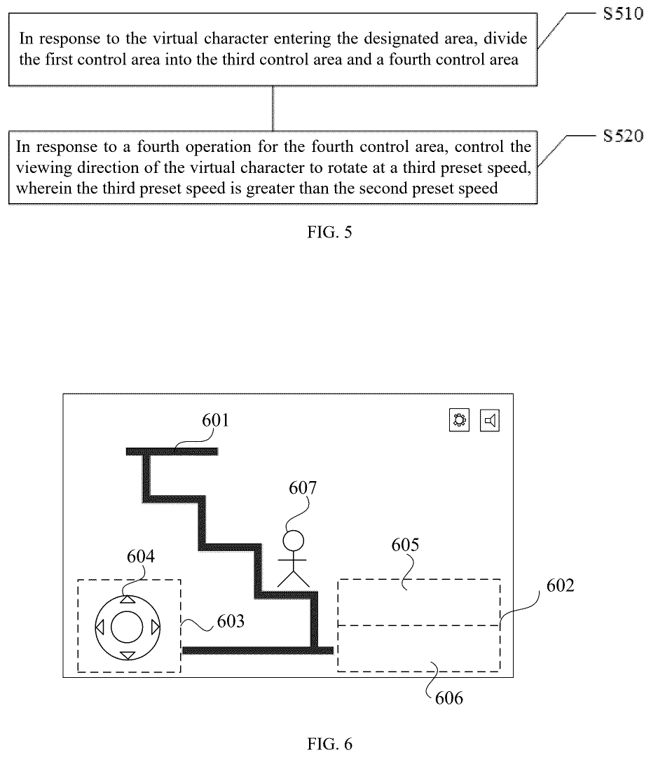

In the embodiment, referring to FIG. 5, in response to the virtual character entering the designated area, generating the third control area in the graphical user interface may include:
in step S510, in response to the virtual character entering the designated area, the first control area is divided into the third control area and a fourth control area; and
in step S520, in response to a fourth operation for the fourth control area, the viewing direction of the virtual character is controlled to rotate at a third preset speed;
the third preset speed is greater than the second preset speed.

In the following, the steps S510 and S520 will be further explained and illustrated. Specifically, when the user controls the virtual character to enter the designated area, in response to the virtual character entering the designated area, the first control area is divided into the third control area and the fourth control area, and the user can control, in the third control area or in the fourth control area, the viewing direction of the virtual character. When the user performs the fourth operation in the fourth control area and controls the viewing direction of the virtual character through the fourth operation, the viewing direction of the virtual character is controlled to rotate at the third preset speed, the third preset speed is greater than the second preset speed, and the third preset speed is equal to the first preset speed. That is, when the virtual character enters the designated area, the first control area can be divided into the third control area and the fourth control area, the rotation speed of the viewing direction of the virtual character corresponding to the fourth control area is greater than the rotation speed of the viewing direction of the virtual character corresponding to the third control area.

Referring to FIG. 6, when the user controls the virtual character to enter the designated area, the graphical user interface includes a designated area 601, a first control area 602, a second control area 603, an operation control 604 in the second control area, a third control area 605, a fourth control area 606, and a virtual character 607. That is, in FIG. 6, when the designated area is stairs and the virtual character is located on the stairs in the designated area 601, the first control area is controlled to be divided into the third control area and the fourth control area, and the change of the control area in the graphical user interface can serve as a prompt to the user.

In the embodiment, when generating the third control area in the graphical user interface, the method for controlling the virtual character may include:
generating reminder information for the third control area in the graphical user interface.

Specifically, when the third control area is generated in the user graphical interface, the reminder information for the third control area can be generated in the graphical user interface. The reminder information can be a highlight display of the third control area, or can be a text prompt in the graphical user interface that indicates the change of the control area. The reminder information is not specifically limited in the embodiment.

Further, in the embodiment, when the virtual object enters the designated area, the designated area is an edge area of a virtual object in the virtual scene. The virtual object is an object in which the virtual character can walk. In the designated area, that is, when the virtual character is in the edge area of the virtual object, if the user's operation habit remains unchanged, it is highly likely to accidentally trigger the vaulting operation. For example, in a case where the open world game is a wilderness-themed game, when a building model appears in the scene, since various stairs often appear in the building model, when the user controls the virtual character to enter the interior of the building and move on the stairs, a wall vaulting operation is often triggered by mistake, that is, the virtual character directly vaults down from the stairs. Therefore, the stairs or the like in the building model can be marked as the designated area. In other models of the game scene, the designated areas in other models can be determined according to actual conditions. In the embodiment, the designated area is not specifically limited. The game scene can include one designated area or a plurality of designated areas. In the embodiment, the number of designated areas included is not specifically limited.

Furthermore, when it is determined whether the virtual character is located in the designated area, a position of the designated area in the game scene can be obtained, and a position of the virtual character in the game scene can be obtained in real time. When the position of the virtual character in the game scene is located at the position of the designated area in the game scene, it is determined that the virtual character is located in the designated area.

Furthermore, in a case where the first control area is divided into the third control area and the fourth control area, when the user controls the virtual character to move on the stairs in the designated area, if the virtual character goes up or down the stairs, the user can perform the fourth operation in the fourth control area to control the viewing direction rotation speed when the virtual character goes up or down the stairs to be the third preset speed. When the virtual character is at the corner of the stairs, the user can perform the third operation in the third control area to control the viewing direction rotation speed of the virtual character to be the second preset speed, that is, the viewing direction rotation speed at the corner of the stairs is less than the viewing direction rotation speed during going up or down the stairs, thereby avoiding accidental triggering of the vaulting operation due to the excessive viewing rotation speed at the corner of the stairs, and improving the user's gaming experience.

In the embodiment, the method for controlling the virtual character further includes:
in response to the virtual character entering the designated area, controlling the virtual character to perform a vaulting action when a current state of the virtual character meets a preset condition.

Specifically, after the user controls the virtual character to enter the designated area, when the current state of the virtual character meets the preset condition, the virtual character can be controlled to perform the vaulting operation. The preset condition may include that in a case where the virtual character is in a moving state and the virtual character moves in the designated area, when the virtual character moves along a certain movement direction, there is an obstacle in the movement direction, and the virtual character jumps up, a height from the lowest point of the virtual character to the ground in the designated area is higher than a height of the obstacle. In the embodiment, the jumping height of the virtual character is not specifically limited. In addition, when the virtual character is fighting in the designated area or the virtual character is at an edge of a prohibited entry part in the designated area, the automatic vaulting function can be canceled.

In the step S140, in response to the third operation for the third control area, the viewing direction of the virtual character is controlled to rotate at the second preset speed. The first preset speed is greater than the second preset speed.

In the embodiment, in response to the virtual character entering the designated area, when the user controls the viewing direction of the virtual character through the third control area, the viewing direction of the virtual character rotates at the second preset speed. After the viewing direction of the virtual character is controlled to rotate at the second preset speed, the method for controlling the virtual character further includes:
in response to end of the third operation, determining, as a target viewing direction, a corresponding viewing direction after the viewing direction of the virtual character rotates at the second preset speed.

Specifically, when the user performs the third operation in the third control area, the viewing direction of the virtual character can be determined through the third operation and the second preset speed. However, when the third operation of the user in the third control area ends, in response to the end of the third operation, the viewing direction of the virtual character can be determined by the corresponding viewing direction after rotation at the second preset speed, that is, the corresponding viewing direction after rotation at the second preset speed is determined as the target viewing direction.

In an embodiment, when the third operation of the user in the third control area ends and the user performs a fifth operation in the second control area, the method for controlling the virtual character further includes:
in response to the fifth operation for the second control area, controlling the virtual character to move in the target viewing direction.

Specifically, in the graphical user interface, the user can operate in the second control area and the third control area at the same time to control the movement of the virtual character. When the user completes the operation in the third control area and is still performing the fifth operation in the second control area, in response to the fifth operation of the user, the virtual object is controlled, through the fifth operation, to move in the target viewing direction. The target viewing direction is a corresponding viewing direction after the virtual character's viewing direction rotates, after the third operation ends, at the second preset speed.

Further, in the present disclosure, when the virtual character leaves the designated area, the method for controlling the virtual character includes:
in response to the virtual character leaving the designated area, deleting the third control area.

Specifically, when the user controls the virtual character to leave the designated area, the third control area in the graphical user interface is deleted in response to the virtual character leaving the designated area. That is, after the virtual character leaves the designated area, when the user controls the viewing direction of the virtual character, the viewing direction of the virtual character rotates at the first preset speed.

The method for controlling the virtual character provided by embodiments of the present disclosure has at least the following advantages: on the one hand, in response to the user's first operation in the first control area and the user's second operation in the second control area, the movement of the virtual character is determined according to both the first operation in the first control area and the second operation in the second control area. However, when the virtual character enters the designated area, the third control area is generated in the graphical user interface, and the change of the control area serves as a prompt to the user. On the other hand, when the virtual character enters the designated area, in response to the user's third operation for the third control area, the viewing direction of the virtual character is controlled by the third operation, the viewing rotation speed of the virtual character in the third control area is less than the viewing rotation speed of the virtual character in the first control area, that is, when the third operation is performed in the third control area, the viewing direction of the virtual character will be controlled to be at a smaller viewing rotation speed, thereby avoiding the problem of accidental vaulting or falling caused by the user's misoperation in the designated area, improving the user's gaming feel in complex scenes, reducing the response frequency of the hardware device, and facilitating to save the computing resources of the hardware device.

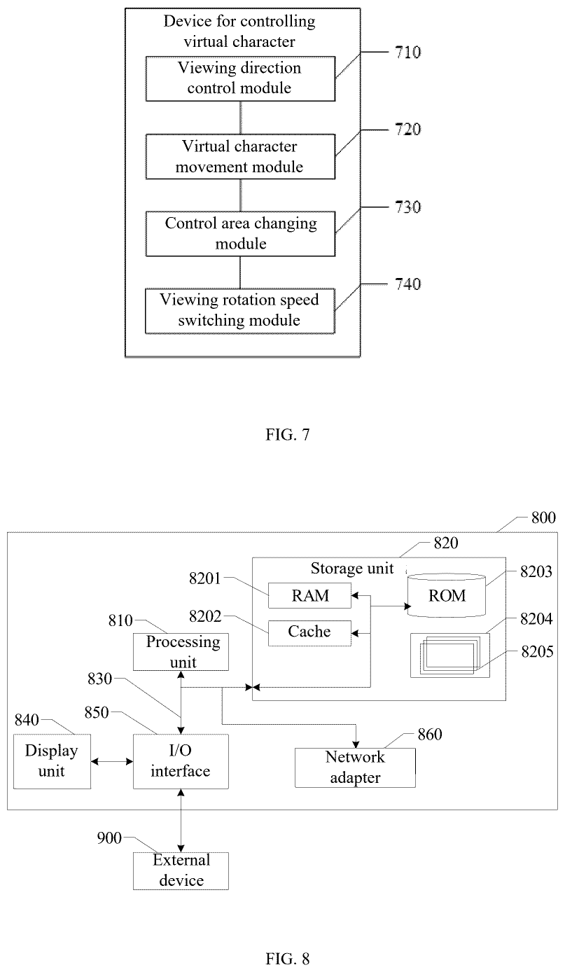

Embodiments of the present disclosure further provide a device for controlling a virtual character. A graphical user interface is provided by a terminal device, the graphical user interface at least includes a first control area, a second control area, a game scene, and the virtual character. As shown in FIG. 7, the device may include a viewing direction control module 710, a virtual character movement module 720, a control area changing module 730 and a viewing rotation speed switching module 740.

The viewing direction control module 710 is configured to, in response to a first operation for a first control area, control a viewing direction of the virtual character to rotate at a first preset speed.

The virtual character movement module 720 is configured to, in response to a second operation for a second control area, control the virtual character to move in a current viewing direction.

The control area changing module 730 is configured to, in response to the virtual character entering a designated area, generate a third control area in a graphical user interface.

The viewing rotation speed switching module 740 is configured to, in response to a third operation for the third control area, control the viewing direction of the virtual character to rotate at a second preset speed.

The first preset speed is greater than the second preset speed.

Specific details of individual modules in the above device for controlling the virtual character have been described in details in the corresponding method for controlling the virtual character, which will not be repeated here.

In an embodiment of the present disclosure, in response to the virtual character entering the designated area, generating the third control area in the graphical user interface includes:
in response to the virtual character entering the designated area, switching the first control area to the third control area.

In an embodiment of the present disclosure, in response to the virtual character entering the designated area, generating the third control area in the graphical user interface includes:
in response to the virtual character entering the designated area, dividing the first control area into the third control area and a fourth control area; and
in response to a fourth operation for the fourth control area, controlling the viewing direction of the virtual character to rotate at a third preset speed;
wherein the third preset speed is greater than the second preset speed.

In an embodiment of the present disclosure, the third preset speed is equal to the first preset speed.

In an embodiment of the present disclosure, the designated area is an edge area of a virtual object in the virtual scene, and the virtual object is an object in which the virtual character is allowed to walk.

In an embodiment of the present disclosure, the method further includes:
in response to the virtual character entering the designated area, controlling the virtual character to perform a vaulting action when a current state of the virtual character meets a preset condition.

In an embodiment of the present disclosure, when generating the third control area in the graphical user interface, the method further includes:
generating reminder information for the third control area in the graphical user interface.

In an embodiment of the present disclosure, after controlling the viewing direction of the virtual character to rotate at the second preset speed, the method further includes:
in response to end of the third operation, determining, as a target viewing direction, a corresponding viewing direction after the viewing direction of the virtual character rotates at the second preset speed.

In an embodiment of the present disclosure, the method further includes:
in response to a fifth operation for the second control area, controlling the virtual character to move in the target viewing direction.

In an embodiment of the present disclosure, the method further includes:
in response to the virtual character leaving the designated area, deleting the third control area.

It should be noted that although several modules or units of the device for performing actions are mentioned in the above detailed description, such division of modules or units is not mandatory. In fact, features and functions of two or more of the modules or units described above may be embodied in one module or unit in accordance with embodiments of the present disclosure. Conversely, the features and functions of one module or unit described above may be further divided into a plurality of modules or units.

In addition, although the various steps of the method of the present disclosure are described in a particular order in the figures, this is not required or implied that the steps must be performed in the particular order, or all the steps shown must be performed to achieve the desired result. Additionally or alternatively, certain steps may be omitted, multiple steps may be combined into one step, and/or one step may be decomposed into multiple steps and so on.

In embodiments of the present disclosure, there is further provided an electronic device capable of implementing the above method.

Those skilled in the art can understand that various aspects of the present disclosure may be implemented as a system, a method, or a program product. Therefore, various aspects of the present disclosure can be embodied in the following forms: a complete hardware implementation, a complete software implementation (including firmware, microcode, etc.), or a combination of hardware and software, which can be collectively referred to as “circuit”, “module”, or “system”.

An electronic device 800 according to such embodiment of the present disclosure is described below with reference to FIG. 8. The electronic device 800 shown in FIG. 8 is only an example and should not bring any limitations to functions and a scope of use of embodiments of the present disclosure.

As shown in FIG. 8, the electronic device 800 takes the form of a general-purpose computing device. Components of the electronic device 800 may include, but are not limited to: at least one processing unit 810, at least one storage unit 820, a bus 830 connecting different system components (including the storage unit 820 and the processing unit 810), and a display unit 840.

The storage unit stores program codes, and the program codes may be executed by the processing unit 810, so that the processing unit 810 performs steps according to various embodiments of the present disclosure described in the above-mentioned “Example Method” section of this specification.

For example, the steps shown in FIG. 1 may be performed, that is, in the step S110, in response to a first operation for a first control area, a viewing direction of the virtual character is controlled to rotate at a first preset speed; in the step S120, in response to a second operation for a second control area, the virtual character is controlled to move in a current viewing direction; in the step S130, in response to the virtual character entering a designated area, a third control area is generated in a graphical user interface; and in the step S140, in response to a third operation for the third control area, the viewing direction of the virtual character is controlled to rotate at a second preset speed. The first preset speed is greater than the second preset speed.

In an embodiment of the present disclosure, based on the aforementioned scheme, in response to the virtual character entering the designated area, generating the third control area in the graphical user interface can be achieved by executing the following steps: in response to the virtual character entering the designated area, switching the first control area to the third control area.

In an embodiment of the present disclosure, based on the aforementioned scheme, in response to the virtual character entering the designated area, generating the third control area in the graphical user interface can be achieved by executing the following steps: in response to the virtual character entering the designated area, dividing the first control area into the third control area and a fourth control area; and in response to a fourth operation for the fourth control area, controlling the viewing direction of the virtual character to rotate at a third preset speed; wherein the third preset speed is greater than the second preset speed.

In an embodiment of the present disclosure, based on the aforementioned scheme, the third preset speed is equal to the first preset speed.

In an embodiment of the present disclosure, based on the aforementioned scheme, the designated area is an edge area of a virtual object in the virtual scene, and the virtual object is an object in which the virtual character is allowed to walk.

In an embodiment of the present disclosure, based on the aforementioned scheme, the following steps may also be performed: in response to the virtual character entering the designated area, controlling the virtual character to perform a vaulting action when a current state of the virtual character meets a preset condition.

In an embodiment of the present disclosure, based on the aforementioned scheme, when the third control area is generated in the graphical user interface, the following steps may also be performed: generating reminder information for the third control area in the graphical user interface.

In an embodiment of the present disclosure, based on the aforementioned scheme, after controlling the viewing direction of the virtual character to rotate at the second preset speed, the following steps may also be performed: in response to end of the third operation, determining, as a target viewing direction, a corresponding viewing direction after the viewing direction of the virtual character rotates at the second preset speed.

In an embodiment of the present disclosure, based on the aforementioned scheme, the following steps may also be performed: in response to a fifth operation for the second control area, controlling the virtual character to move in the target viewing direction.

In an embodiment of the present disclosure, based on the aforementioned scheme, the following steps may also be performed: in response to the virtual character leaving the designated area, deleting the third control area.

On the one hand, in response to the user's first operation in the first control area and the user's second operation in the second control area, the movement of the virtual character is determined according to both the first operation in the first control area and the second operation in the second control area. However, when the virtual character enters the designated area, the third control area is generated in the graphical user interface, and the change of the control area serves as a prompt to the user. On the other hand, when the virtual character enters the designated area, in response to the user's third operation for the third control area, the viewing direction of the virtual character is controlled by the third operation, the viewing rotation speed of the virtual character in the third control area is less than the viewing rotation speed of the virtual character in the first control area, that is, when the third operation is performed in the third control area, the viewing direction of the virtual character will be controlled to be at a smaller viewing rotation speed, thereby avoiding the problem of accidental vaulting or falling caused by the user's misoperation in the designated area, improving the user's movement feel in complex scenes, reducing the response frequency of the hardware device, and facilitating to save the computing resources of the hardware device.

The storage unit 820 may include a readable medium in the form of a volatile storage unit, such as a random access storage unit (RAM) 8201 and/or a cache storage unit 8202, and may further include a read-only storage unit (ROM) 8203.

The storage unit 820 may further include a program/utility tool 8204 having a set (at least one) of program modules 8205. Such program modules 8205 include, but are not limited to, an operating system, one or more application programs, other program modules, and program data. Each or some combination of these examples may include an implementation of a network environment.

The bus 830 may be one or more of several types of bus structures, including a memory unit bus or a memory unit controller, a peripheral bus, a graphics acceleration port, a processing unit, or a local area bus using any bus structure in a variety of bus structures.

The electronic device 800 may also communicate with one or more external devices 900 (such as a keyboard, a pointing device, a Bluetooth device, etc.), and may also communicate with one or more devices that enable a user to interact with the electronic device 800, and/or may also communicate with any device (such as a router, a modem) that can enable the electronic device 800 to interact with one or more other computing devices. Such communication may be performed through an input/output (I/O) interface 850. Moreover, the electronic device 800 may also communicate with one or more networks (such as a local area network (LAN), a wide area network (WAN), and/or a public network, such as the Internet) through the network adapter 860. As shown in the figure, the network adapter 860 communicates with other modules of the electronic device 800 through the bus 830. It should be understood that although not shown in the figure, other hardware and/or software modules may be used in conjunction with the electronic device 800, including but not limited to: microcode, device drivers, redundant processing units, external disk drive arrays, RAID systems, tape drives and data backup storage systems.

Through the description of the foregoing embodiments, those skilled in the art can easily understand that the example embodiments described herein may be implemented by software, or by software in combination with necessary hardware. Therefore, the technical solutions according to the embodiments of the present disclosure may be embodied in the form of a software product, and the software product may be stored in a non-volatile storage medium (which may be a CD-ROM, a U disk, a mobile hard disk, etc.) or on a network. The software product may include instructions to cause a computing device (which may be a personal computer, a server, a terminal device, or a network device, etc.) to execute the method according to embodiments of the present disclosure.

In an embodiment of the present disclosure, there is further provided a computer-readable storage medium having a program product stored thereon which is capable of implementing the method described above in this specification. In some embodiments of the present disclosure, various aspects of the present disclosure may also be implemented in the form of a program product, which includes program codes. When the program product is run on a terminal device, the program code is used to cause the terminal device to perform steps according to various embodiments of the present disclosure described in the above-mentioned “Example Method” section of this specification.

For example, the steps shown in FIG. 1 may be performed, that is, in the step S110, in response to a first operation for a first control area, a viewing direction of the virtual character is controlled to rotate at a first preset speed; in the step S120, in response to a second operation for a second control area, the virtual character is controlled to move in a current viewing direction; in the step S130, in response to the virtual character entering a designated area, a third control area is generated in a graphical user interface; and in the step S140, in response to a third operation for the third control area, the viewing direction of the virtual character is controlled to rotate at a second preset speed. The first preset speed is greater than the second preset speed.

In an embodiment of the present disclosure, based on the aforementioned scheme, in response to the virtual character entering the designated area, generating the third control area in the graphical user interface can be achieved by executing the following steps: in response to the virtual character entering the designated area, switching the first control area to the third control area.

In an embodiment of the present disclosure, based on the aforementioned scheme, in response to the virtual character entering the designated area, generating the third control area in the graphical user interface can be achieved by executing the following steps: in response to the virtual character entering the designated area, dividing the first control area into the third control area and a fourth control area; and in response to a fourth operation for the fourth control area, controlling the viewing direction of the virtual character to rotate at a third preset speed; wherein the third preset speed is greater than the second preset speed.

In an embodiment of the present disclosure, based on the aforementioned scheme, the third preset speed is equal to the first preset speed.

In an embodiment of the present disclosure, based on the aforementioned scheme, the designated area is an edge area of a virtual object in the virtual scene, and the virtual object is an object in which the virtual character is allowed to walk.

In an embodiment of the present disclosure, based on the aforementioned scheme, the following steps may also be performed: in response to the virtual character entering the designated area, controlling the virtual character to perform a vaulting action when a current state of the virtual character meets a preset condition.

In an embodiment of the present disclosure, based on the aforementioned scheme, when the third control area is generated in the graphical user interface, the following steps may also be performed: generating reminder information for the third control area in the graphical user interface.

In an embodiment of the present disclosure, based on the aforementioned scheme, after controlling the viewing direction of the virtual character to rotate at the second preset speed, the following steps may also be performed: in response to end of the third operation, determining, as a target viewing direction, a corresponding viewing direction after the viewing direction of the virtual character rotates at the second preset speed.

In an embodiment of the present disclosure, based on the aforementioned scheme, the following steps may also be performed: in response to a fifth operation for the second control area, controlling the virtual character to move in the target viewing direction.

In an embodiment of the present disclosure, based on the aforementioned scheme, the following steps may also be performed: in response to the virtual character leaving the designated area, deleting the third control area.

On the one hand, in response to the user's first operation in the first control area and the user's second operation in the second control area, the movement of the virtual character is determined according to both the first operation in the first control area and the second operation in the second control area. However, when the virtual character enters the designated area, the third control area is generated in the graphical user interface, and the change of the control area serves as a prompt to the user. On the other hand, when the virtual character enters the designated area, in response to the user's third operation for the third control area, the viewing direction of the virtual character is controlled by the third operation, the viewing rotation speed of the virtual character in the third control area is less than the viewing rotation speed of the virtual character in the first control area, that is, when the third operation is performed in the third control area, the viewing direction of the virtual character will be controlled to be at a smaller viewing rotation speed, thereby avoiding the problem of accidental vaulting or falling caused by the user's misoperation in the designated area, improving the user's movement feel in complex scenes, reducing the response frequency of the hardware device, and facilitating to save the computing resources of the hardware device.

The program product for implementing the above-mentioned method according to an embodiment of the present disclosure may take the form of a portable Compact Disc Read-Only Memory (CD-ROM) and include program codes, and may be run on a terminal device, such as a personal computer. However, the program product of the present disclosure is not limited thereto. The readable storage medium herein may be any tangible medium containing or storing a program, and the program may be used by an instruction execution system, an apparatus, or a device, or the program may be used in combination with the instruction execution system, the apparatus, or the device.

The program product may be any combination of one or more readable mediums. The readable medium may be a readable signal medium or a readable storage medium. The readable storage medium may be, for example, but is not limited to, electronic, magnetic, optical, electromagnetic, infrared, or a semiconductor system, apparatus, or device, or any combination thereof. More specific examples (non-exhaustive examples) of readable storage media include: electrical connection with one or more wires, portable disk, hard disk, random access memory (RAM), read-only memory (ROM), erasable programmable read-only memory (EPROM or flash memory), optical fiber, portable compact disc read-only memory (CD-ROM), optical storage device, magnetic storage device, or any suitable combination of the foregoing.

The computer-readable signal medium may include a data signal in baseband or propagated as part of a carrier wave, which carries readable program codes. Such a propagated data signal may have many forms, including but not limited to electromagnetic signals, optical signals, or any suitable combination of the foregoing. The readable signal medium may also be any readable medium other than a readable storage medium, and the readable medium may send, propagate, or transmit a program that is used by an instruction execution system, apparatus, or device, or that is used in combination with an instruction execution system, apparatus, or device.

The program codes contained on the readable medium may be transmitted using any appropriate medium, including but not limited to wireless, wired, optical fiber, RF, etc., or any suitable combination of the foregoing.

The program codes for performing the operations of the present disclosure may be written in any combination of one or more programming languages, which include object-oriented programming languages, such as Java, C++, and so on. The programming languages also include conventional procedural programming language, such as “C” or a similar programming language. The program codes may be executed entirely on the user computing device, may be executed partly on the user device, may be executed as an independent software package, may be executed partly on the user computing device and partly on a remote computing device, or may be executed entirely on the remote computing device or server. In the case of a remote computing device, the remote computing device may be connected to the user computing device through any kind of network, including a local area network (LAN) or a wide area network (WAN), or the remote computing device may be connected to an external computing device, for example, by the Internet provided by the Internet service providers.

In addition, the above-mentioned drawings are only schematic illustrations of processes included in the method according to embodiments of the present disclosure, and are not intended to be limiting. It is easy to understand that the processes shown in the above-mentioned drawings do not indicate or limit the time sequence of these processes. In addition, it is also easy to understand that these processes can be performed synchronously or asynchronously, for example, in multiple modules.

Other embodiments of the present disclosure will be apparent to those skilled in the art from consideration of the specification and practice of the present disclosure disclosed herein. The present disclosure is intended to cover any variations, uses, or adaptations of the present disclosure, which are in accordance with the general principles of the present disclosure and include common general knowledge or conventional technical means in the art that are not disclosed in the present disclosure. The specification and embodiments are illustrative, and the real scope and spirit of the present disclosure is defined by the appended claims.

1. A method for controlling a virtual character, comprising:
in response to a first operation for a first control area, controlling a viewing direction of the virtual character to rotate at a first preset speed, wherein a graphical user interface is provided by a terminal device, the graphical user interface at least comprises the first control area, a second control area, a game scene and the virtual character;
in response to a second operation for the second control area, controlling the virtual character to move in a current viewing direction;
in response to the virtual character entering a designated area, generating a third control area in the graphical user interface; and
in response to a third operation for the third control area, controlling the viewing direction of the virtual character to rotate at a second preset speed;
wherein the first preset speed is greater than the second preset speed.

2. The method according to claim 1, wherein in response to the virtual character entering the designated area, generating the third control area in the graphical user interface comprises:
in response to the virtual character entering the designated area, switching the first control area to the third control area.

3. The method according to claim 1, wherein in response to the virtual character entering the designated area, generating the third control area in the graphical user interface comprises:
in response to the virtual character entering the designated area, dividing the first control area into the third control area and a fourth control area; and
in response to a fourth operation for the fourth control area, controlling the viewing direction of the virtual character to rotate at a third preset speed;
wherein the third preset speed is greater than the second preset speed.

4. The method according to claim 3, wherein the third preset speed is equal to the first preset speed.

5. The method according to claim 1, wherein the designated area is an edge area of a virtual object in the virtual scene, and the virtual object is an object in which the virtual character is allowed to walk.

6. The method according to claim 1, wherein the method further comprises:
in response to the virtual character entering the designated area, controlling the virtual character to perform a vaulting action when a current state of the virtual character meets a preset condition.

7. The method according to claim 1, wherein the method further comprises:
generating reminder information for the third control area in the graphical user interface.

8. The method according to claim 1, wherein the method further comprises:
in response to end of the third operation, determining, as a target viewing direction, a corresponding viewing direction after the viewing direction of the virtual character rotates at the second preset speed.

9. The method according to claim 8, wherein the method further comprises:
in response to a fifth operation for the second control area, controlling the virtual character to move in the target viewing direction.

10. The method according to claim 1, wherein the method further comprises:
in response to the virtual character leaving the designated area, deleting the third control area.

11. (canceled)

12. A non-transitory computer storage medium having a computer program stored thereon, wherein the computer program, when executed by a processing unit, implements the following operations:
in response to a first operation for a first control area, controlling a viewing direction of the virtual character to rotate at a first preset speed, wherein a graphical user interface is provided by a terminal device, the graphical user interface at least comprises the first control area, a second control area, a game scene and the virtual character;
in response to a second operation for the second control area, controlling the virtual character to move in a current viewing direction;
in response to the virtual character entering a designated area, generating a third control area in the graphical user interface; and
in response to a third operation for the third control area, controlling the viewing direction of the virtual character to rotate at a second preset speed;
wherein the first preset speed is greater than the second preset speed.

13. An electronic device, comprising:
a processing unit; and
a storage unit, configured to store executable instructions of the processing unit;
wherein the processing unit is configured to execute, by executing the executable instructions, the following operations:
in response to a first operation for a first control area, controlling a viewing direction of the virtual character to rotate at a first preset speed, wherein a graphical user interface is provided by a terminal device, the graphical user interface at least comprises the first control area, a second control area, a game scene and the virtual character;
in response to a second operation for the second control area, controlling the virtual character to move in a current viewing direction;
in response to the virtual character entering a designated area, generating a third control area in the graphical user interface; and
in response to a third operation for the third control area, controlling the viewing direction of the virtual character to rotate at a second preset speed;
wherein the first preset speed is greater than the second preset speed.

14. The method according to claim 1, wherein the game scene comprises one designated area or a plurality of designated areas.

15. The method according to claim 1, wherein the method further comprises:
determining whether the virtual character is located in the designated area.

16. The method according to claim 15, wherein determining whether the virtual character is located in the designated area comprises:
obtaining a position of the designated area in the game scene;
obtaining a position of the virtual character in the game scene in real time; and
in response to the position of the virtual character in the game scene being located at the position of the designated area in the game scene, determining the virtual character is located in the designated area.

17. The non-transitory computer storage medium according to claim 12, wherein the computer program, when executed by the processing unit, implements:
in response to the virtual character entering the designated area, switching the first control area to the third control area.

18. The non-transitory computer storage medium according to claim 12, wherein the computer program, when executed by the processing unit, implements:
in response to the virtual character entering the designated area, dividing the first control area into the third control area and a fourth control area; and
in response to a fourth operation for the fourth control area, controlling the viewing direction of the virtual character to rotate at a third preset speed;
wherein the third preset speed is greater than the second preset speed.

19. The non-transitory computer storage medium according to claim 12, wherein the designated area is an edge area of a virtual object in the virtual scene, and the virtual object is an object in which the virtual character is allowed to walk.

20. The electronic device according to claim 13, wherein the processing unit is configured to:
in response to the virtual character entering the designated area, switch the first control area to the third control area.

21. The electronic device according to claim 13, wherein the processing unit is configured to:
in response to the virtual character entering the designated area, divide the first control area into the third control area and a fourth control area; and
in response to a fourth operation for the fourth control area, control the viewing direction of the virtual character to rotate at a third preset speed;
wherein the third preset speed is greater than the second preset speed.
